(19) United States
(12) Patent Application Publication
(10) Pub. No.: US 2026/0281898 A1
(43) Pub. Date: Sep. 17, 2026

(54) ENERGY STATE BASED SCHEDULING

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Wei YANG, San Diego, CA (US); Linhai HE, San Diego, CA (US); Huilin XU, Beijing (CN); Peter GAAL, San Diego, CA (US); Krishna Kiran MUKKAVILLI, San Diego, CA (US); Le LIU, San Jose, CA (US); Wanshi CHEN, San Diego, CA (US); Yiqing CAO, Beijing (CN)

(21) Appl. No.: 19/157,645

(22) PCT Filed: Mar. 28, 2023
(86) PCT No.: PCT/CN2023/084248

§ 371 Date: Aug. 18, 2025

(51) Int. Cl. H04W 52/02

(52) U.S. Cl. CPC H04W 52/0225

(57) ABSTRACT

Various aspects of the present disclosure generally relate to wireless communication. In some aspects, a wireless communication device may perform a first communication with a first tag, based at least in part on a first energy state or a first priority of the first tag, using a first communication configuration, wherein the first communication configuration indicates a first communication occasion for the first communication. The wireless communication device may perform a second communication with a second tag, based at least in part on a second energy state or a second priority of the second tag, using a second communication configuration, wherein the second communication configuration indicates a second communication occasion for the second communication. Numerous other aspects are described.

### FIELD OF THE DISCLOSURE

Aspects of the present disclosure generally relate to wireless communication and to techniques and apparatuses for energy state based scheduling.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a wireless communication device. The method may include performing a first communication with a first tag, based at least in part on a first energy state or a first priority of the first tag, using a first communication configuration, wherein the first communication configuration indicates a first communication occasion for the first communication. The method may include performing a second communication with a second tag, based at least in part on a second energy state or a second priority of the second tag, using a second communication configuration, wherein the second communication configuration indicates a second communication occasion for the second communication.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture.

FIGS. 4A, 4B, 4C, and 4D depict aspects of data structures for a wireless communications network in accordance with the present disclosure.

FIG. 5 is a diagram illustrating an example of backscatter communication, in accordance with the present disclosure.

FIG. 6 is a diagram illustrating an example of power consumption associated with a ambient IoT device, in accordance with the present disclosure.

FIG. 7 is a diagram illustrating an example of signaling relating to communication with tags having different energy states, in accordance with the present disclosure.

FIG. 8 is a diagram illustrating an example of signaling for communication based at least in part on energy states, in accordance with the present disclosure.

FIG. 9 is a diagram illustrating an example of signaling for communication based at least in part on energy states, in accordance with the present disclosure.

FIG. 10 is a diagram illustrating an example of signaling for communication based at least in part on energy states, in accordance with the present disclosure.

FIG. 11 is a diagram illustrating an example of signaling for communication based at least in part on energy states, in accordance with the present disclosure.

FIG. 12 is a diagram illustrating an example of signaling for communication based at least in part on energy states, in accordance with the present disclosure.

FIG. 13 is a diagram illustrating an example of signaling for communication based at least in part on energy states, in accordance with the present disclosure.

FIG. 14 shows a method for wireless communications by a reader.

FIG. 15 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for energy state based scheduling.

A wireless communication device referred to herein as a reader may communicate with wireless communication devices referred to herein as tags. A tag may include a passive device, a semi-passive device, or an active device. A tag may often be powered by harvesting energy from an environment of the tag, such as solar energy, radio frequency energy, or the like. A reader may communicate with multiple different tags in the course of operation. Different tags may have different energy states. For example, the reader may communicate with a first tag having a lower energy state and a second tag having a higher energy state. An energy state may indicate how long a tag can maintain activity before powering down to collect energy for another communication. The different energy states may mean that tags are active for different lengths of time. In some cases, the reader may attempt to communicate with a tag after the tag has deactivated (for example, if the tag is associated with a low energy state). Additionally, or alternatively, the reader may communicate with a tag having a higher energy state before a tag having a lower energy state, such that the tag having the lower energy state runs out of power before communicating with the reader, and the tag having the higher energy state has excess energy after communicating with the reader. Thus, efficiency of communication is decreased and power management of the tags is negatively impacted.

Some techniques described herein provide scheduling of communications of multiple tags based at least in part on energy states of the multiple tags. For example, a wireless communication device (e.g., a reader) may communicate with a first tag and a second tag. The wireless communication device may communicate with the first tag using a first communication configuration, and with the second tag using a second communication configuration. The wireless communication device may communicate with the first tag based at least in part on a first energy state or a first priority of the first tag (e.g., the first communication configuration may be based at least in part on the first energy state), and may communicate with the second tag based at least in part on a second energy state or a second priority of the second tag (e.g., the second communication configuration may be based at least in part on the second energy state). A communication configuration (e.g., the first communication configuration or the second communication configuration) may indicate a communication occasion for a corresponding communication. By communicating in accordance with communication configurations that are based at least in part on energy states of the corresponding tags, scheduling of communications in view of the energy states of the tags is improved. Thus, efficiency of communication is increased. In some examples, a communication configuration may indicate that a tag having a lower energy state is associated with an earlier communication occasion (or a higher priority), or that a tag having a higher energy state is associated with a later communication occasion. Thus, a tag having a lower energy state may be enabled to communicate with a wireless communication device (e.g., a reader) earlier than a tag having a higher energy state, which improves power management of the tags.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

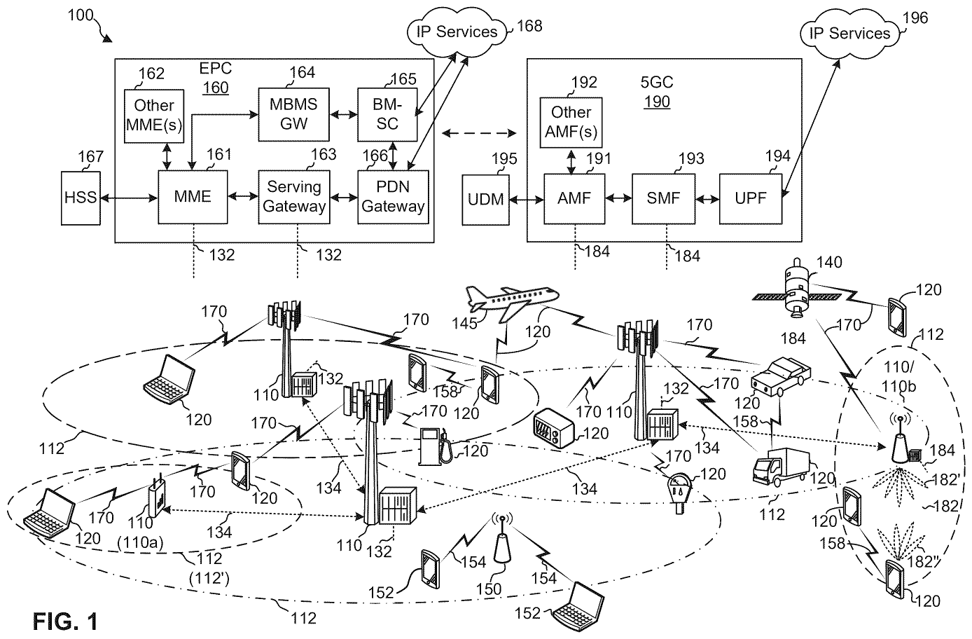

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

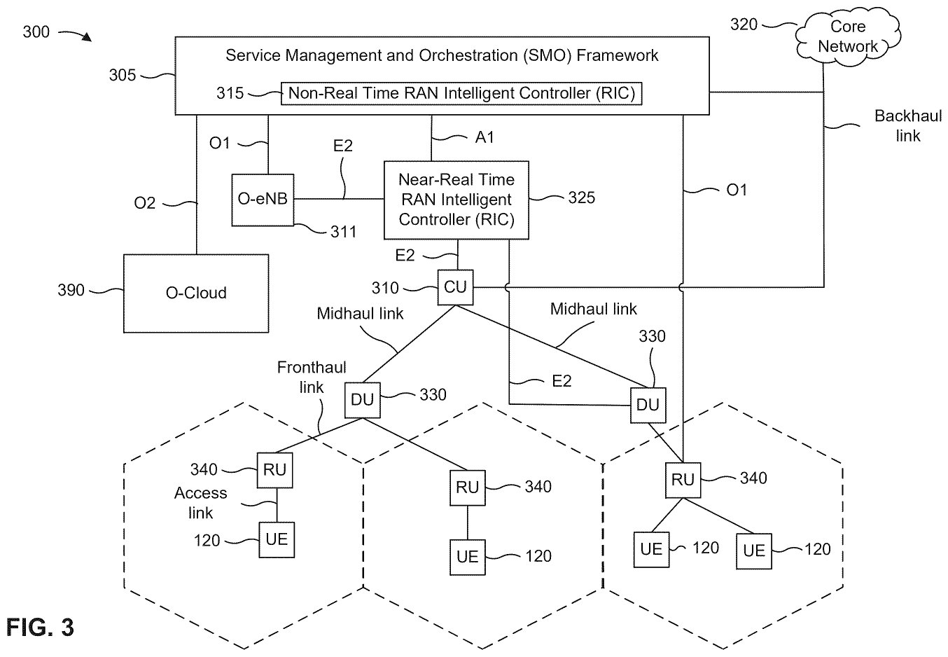

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) radio access network (RAN) Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, the 3rd Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mm Wave or near mmWave radio frequency bands (e.g., a mm Wave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′ UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

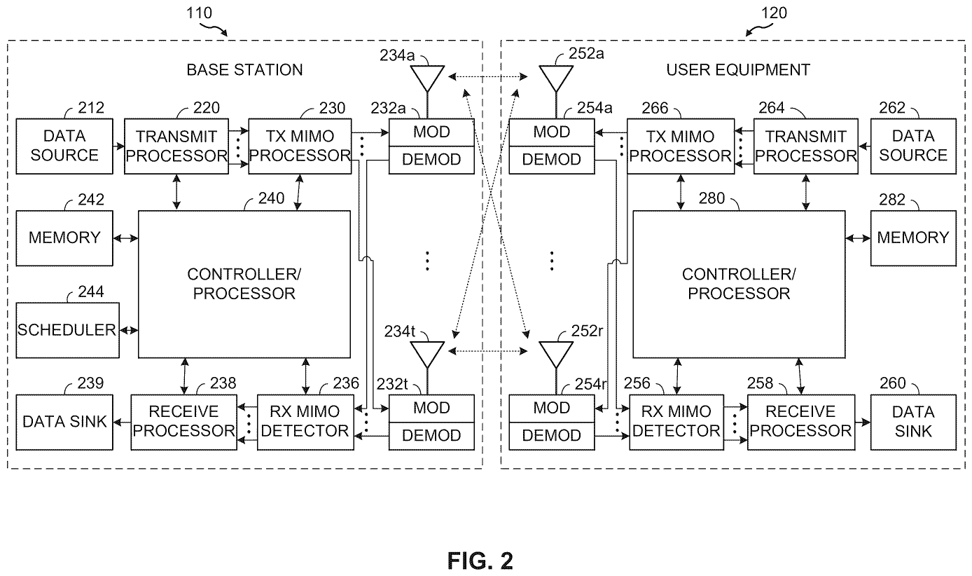

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

Receive (RX) MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provided decoded data for the UE 120 to a data sink 260, and provide decoded control information to a controller/processor 280.

For an example uplink transmission, UE 120 further includes a transmit processor 264 that may receive and process data (e.g., for the physical uplink shared channel) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via (1) or via creation of RAN management policies (such as A1 policies).

As indicated above, FIG. 3 is provided as an example. Other examples may differ from what is described with regard to FIG. 3.

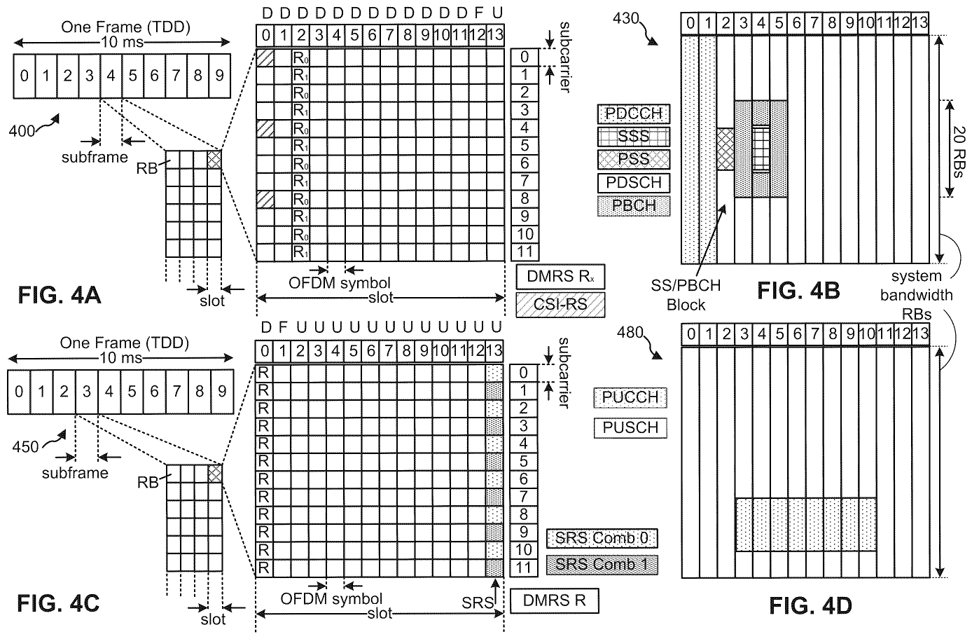

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing. OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the physical uplink shared channel (PUSCH). The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

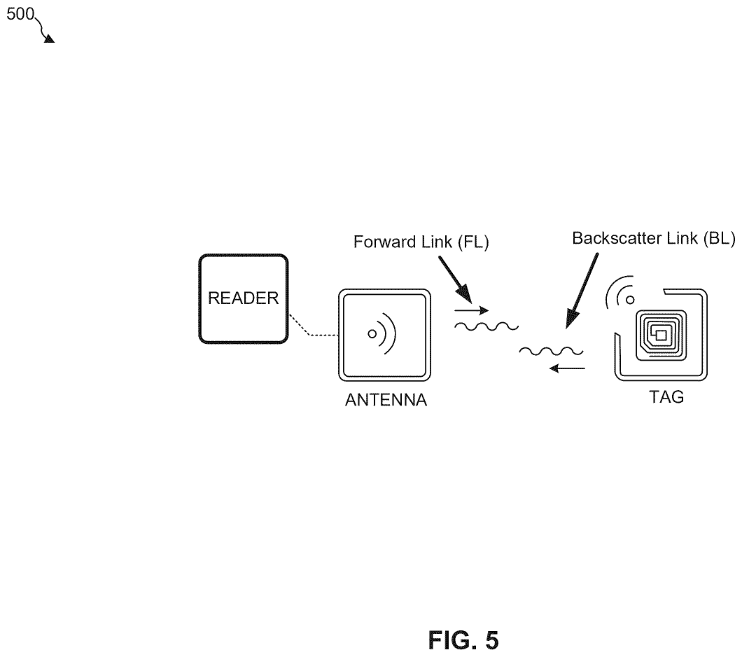

FIG. 5 is a diagram illustrating an example 500 of backscatter communication, in accordance with the present disclosure. Backscatter communication may be used to perform low-power communication between entities, such as between a tag (e.g., a radio frequency identification (RFID) tag, a zero-power IoT device, an ambient IoT device, an energy harvesting device, a UE) and a wireless communication device functioning as a reader of the tag. For example, backscatter communication may facilitate communication for a low-cost or low-power wireless communication device.

Some wireless communication devices may be considered IoT devices, such as ambient IoT devices (sometimes referred to as ultra-light IoT devices), or similar IoT devices. IoT technology may include passive IoT (e.g., NR passive IoT for 5G Advanced), semi-passive IoT, ultra-light IoT, or ambient IoT, among other examples. In passive IoT, a terminal (e.g., a RFID device, a tag, or a similar device) may not include a battery, and the terminal may accumulate energy from radio signaling. The terminal may be a passive UE. A passive UE may be a passive UE without energy storage or a passive UE with energy storage. A passive UE without energy storage may include a capacitor to instantaneously (or near-instantaneously) provide energy from the RF to the passive UE. A passive UE with energy storage may have some limited energy storage capability. Any of these wireless communication devices may be referred to herein as a tag.

The terminal may accumulate solar energy to supplement accumulated energy from radio signaling. In passive IoT, a communication distance may be up to 30 meters (or more) to facilitate feasible network coverage over a large area (e.g., 5000 square meters), such as in a warehouse. Moreover, the power consumption of a passive IoT terminal (e.g., a UE) may be less than 0.1 milliwatts (mW) to support operation without a battery, and the terminal may be relatively inexpensive to facilitate cost-sensitive uses. A positioning accuracy of a passive IoT terminal may be approximately 3-5 meters in the horizontal and the vertical directions.

Passive IoT may be useful in connection with industrial sensors, for which battery replacement may be prohibitively difficult or undesirable (e.g., for safety monitoring or fault detection in smart factories, infrastructures, or environments). Additionally, features of passive IoT devices, such as low cost, small size, maintenance-free, durable, long lifespan, or the like, may facilitate smart logistics/warehousing (e.g., in connection with automated asset management by replacing RFID tags). Furthermore, passive IoT may be useful in connection with smart home networks for household item management, wearable devices (e.g., wearable devices for medical monitoring for which patients do not need to replace batteries), and/or environment monitoring. To achieve further cost reduction and zero-power communication, 5G+/6G wireless networks may utilize a type of passive IoT device referred to as an “ambient backscatter device” or a “backscatter device.” As used herein, “tag” can refer to any device (e.g., any IoT device) capable of performing backscatter communication. In other words, “tag,” as used herein, is not limited to RFID tags. Moreover, “reader” can include a wireless communication device such as a base station 110, a UE 120, a transmitter (e.g., an energizer of a backscatter device), or a combination thereof. In some examples, the transmitter that powers backscatter communication for a tag may be implemented separately from a reader that performs the backscatter communication with the tag. In some other examples, the transmitter and the reader may be co-located or may be the same entity.

As shown in FIG. 5, in a system such as an ultra-high frequency (UHF) RFID system, a reader (e.g., an RFID reader) may be coupled to an antenna, and the reader may communicate with a tag (e.g., an RFID tag), which may be a passive device. The tag may include a dipole antenna and an integrated circuit (IC). The reader may transmit an RF signal via a forward link. The tag may receive the RF signal, and the received RF signal may be reflected from the tag via a backscatter link. The tag may use the received RF signal to transmit data without a battery or power source. The tag may employ a passive reflection and modulation of the received RF signal. When the tag has data to send, the tag may harvest the received RF signal to obtain power to operate. The tag may harvest (or absorb) power from the received RF signal using a rectifier, and the tag may operate using the harvested power. The rectifier may include a diode and a capacitor, and the rectifier may achieve a certain energy conversion efficiency. The tag may modulate the received RF signal to encode the data, and then the tag may reflect (or backscatter) the modulated received RF signal back to the reader in a far-field manner, thereby achieving the backscatter communication. The modulation in the tag may be based at least in part on an IC/antenna resistance match, which may provide a backscatter power, as opposed to an IC/antenna resistance mismatch, which would provide no/minimal backscatter power. A modulation efficiency may be based at least in part on a practical radiation power and an idealized radiation power. The backscatter communication may be associated with a low energy requirement and a low complexity of deployment.

The reader, or interrogator, may include a transmitter, a receiver, and a baseband processor. The antenna coupled to the reader may include a transmit antenna and a receive antenna. The reader may transmit, to the tag, an unmodulated or modulated wave (e.g., a command). The reader may transmit a carrier wave (CW), which may power up the tag. The reader may transmit modulated commands, which may include packets. The modulated commands may indicate values of 0 and 1. The tag may transmit, to the reader, a modulated wave (e.g., a response). A modulated response may include a packet. The modulated response may indicate values of 0 and 1. A reader-tag interaction may be based at least in part on a command-response model.

As indicated above, FIG. 5 is provided as an example. Other examples may differ from what is described with regard to FIG. 5.

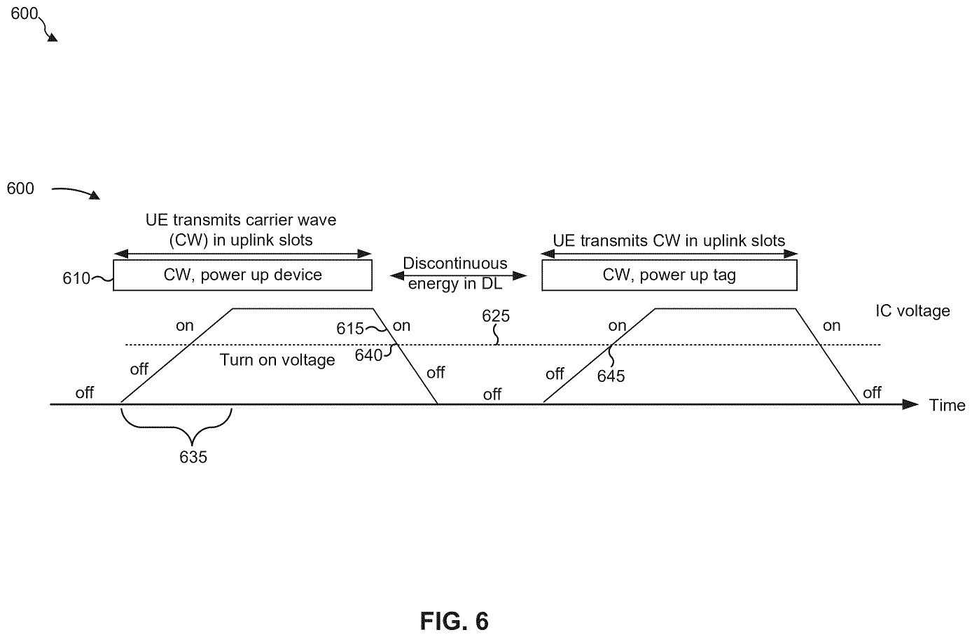

FIG. 6 is a diagram illustrating an example 600 of power consumption associated with a ambient IoT device, in accordance with the present disclosure. Example 600 illustrates power consumption associated with a tag such as an ambient IoT device (e.g., a passive or semi-passive communication device). As used herein, “ambient IoT device” can refer to a fully passive communication device, a semi-passive communication device, or an active communication device. A ambient IoT device may obtain and store energy for transmission by performing energy harvesting and storage. For example, a ambient IoT device may store harvested energy (e.g., harvested using wind energy harvesting, solar energy harvesting, radio wave energization, or the like) using a storage module such as a capacitor. In some aspects, a ambient IoT device's storage module may be non-removable, as compared to removable energy storage such as a button cell. A passive communication device (e.g., a fully passive communication device) may communicate using, for example, backscatter communication without performing energy harvesting or storage. A semi-passive communication device may communicate using, for example, backscatter communication and may perform energy harvesting and storage. An active communication device may communicate using active (e.g., self-powered) transmission, and in some aspects may perform energy harvesting and storage. A ambient IoT device may communicate as a passive communication device (e.g., using backscatter communication), an active communication device (e.g., using a transmission powered by energy harvesting), or both. In some aspects, the ambient IoT devices described herein may perform envelope decoding or detection for receiving. An envelope detector (sometimes called a peak detector) is an electronic circuit that takes a (relatively) high-frequency amplitude modulated signal as input and provides an output, which is the demodulated envelope of the original signal. For example, a ambient IoT device may perform envelope detection using an envelope detector. A semi-passive communication device may also be referred to as a hybrid communication device. A passive communication device, a semi-passive communication device, a hybrid communication device, an active communication device, or a ambient IoT device may be referred to herein as a device.

In some examples, a ambient IoT device may include a passive IoT device. Ambient IoT devices may use passive communication technologies such as backscatter communication, which reduces power consumption and cost. One example of a ambient IoT device is an ultra-high frequency radio frequency identification (UHF RFID) tag, which may utilize backscatter communication. A ambient IoT device may not have sufficient transmit power or reception capabilities to communicate directly with a network node. For example, the ambient IoT device may communicate with a UE, and the UE may facilitate operations of the ambient IoT device. References herein to a tag should be understood to include any ambient IoT device unless indicated otherwise.

As shown by reference number 610, in some examples, a reader and a ambient IoT device may communicate in uplink slots. For example, the reader may transmit a communication (which may be carried on a carrier wave) to the passive communication device, or the ambient IoT device may transmit a communication to the reader, in one or more uplink slots. In some examples, the carrier wave may power up the ambient IoT device. In some examples, the reader and the ambient IoT device may communicate in a slot other than an uplink slot, such as a slot designated for zero-power device communication, a sidelink slot, or the like. In some examples, the carrier wave is an unmodulated wave such as a single-tone unmodulated wave. In some aspects, the carrier wave is a modulated wave. In some aspects, the carrier wave is transmitted by a device other than the reader.

A voltage of the ambient IoT device of example 600 is shown by reference number 615. In some aspects, the voltage may be an IC voltage. The passive communication device may be associated with a voltage threshold, shown by reference number 625. The ambient IoT device may be capable of communicating if (e.g., while) the voltage of the ambient IoT device satisfies the voltage threshold. The voltage threshold is illustrated as a “turn-on voltage” (e.g., a voltage at which the ambient IoT device turns on, or turns on one or more components, for communication).

In example 600, the ambient IoT device's voltage increases in a first time period shown by reference number 635, such as due to harvesting energy or being energized for backscatter communication. The ambient IoT device's voltage increases to satisfy the voltage threshold for a period of time, then drops below the voltage threshold, as shown by reference number 640, such as due to ceasing energy harvesting or ceasing energization for backscatter communication. As shown by reference number 645, the ambient IoT device's voltage again increases to satisfy the voltage threshold.

A tag may be capable of communicating for a length of time before more energy harvesting is needed to support communication operations of the tag. Different tags may have different capabilities. For example, a first tag may be capable of communicating for a longer duration than a second tag. These capabilities may be based on various factors, such as available energy levels in energy storage (e.g., based at least in part on a capacitor size or a voltage of an energy source), whether the tag has energy storage capabilities, whether the tag has active components or not, a discharging rate (which may be based at least in part on whether a low-noise amplifier (LNA) is activated or deactivated, whether a power amplifier (PA) is activated or deactivated, whether a tunnel diode is activated or deactivated, or a combination thereof), a charging rate (which may be based at least in part on a signal strength (e.g., reference signal received power (RSRP) or received signal strength indicator (RSSI)), a signal quality (e.g., reference signal received quality (RSRQ)), or a distance between the tag and a reader), or a combination thereof. A capability indicating how long a tag can remain in a powered-on state (until further energy harvesting is required), which may be based at least in part on the above factors and/or other factors (e.g., how long the tag has already been in a powered-on state, how long the tag has been monitoring a channel), may be referred to herein as an energy state. Energy states are referred to herein as being higher energy states or lower energy states. As used herein, a higher energy state indicates a tag that is capable of a longer powered-on state (that is, a longer activity length or expected activity length) than a tag having a lower energy state. Thus, a low energy state may indicate a short “on” duration (e.g., a short activity length), while a high energy state may indicate a long “on” duration (e.g., a long activity length). An example of energy states based at least in part on parameters of a tag is provided in Table 1, below:

TABLE 1

| Example | | Energy state |
|---|---|---|
| Tag class | Passive tag (no energy | High (e.g., 3) |
| | source (ES)) | |
| | Semi-passive tag, active tag | Medium (e.g., 2) |
| | active tag | Low (e.g., 1) |
| Active | Tag with LNA (PA, tunnel | High |
| components state | diode, etc.) off | |
| | Tag with LNA (PA, tunnel | Low |
| | diode, etc.) on | |
| Capacitor size | Small | Low |
| | Large | High |
| Distance | Far | Low |
| (or RSSI, RSRQ, RSRP) | Near | High |

A reader may communicate with multiple different tags in the course of operation. As mentioned, different tags may have different energy states. For example, the reader may communicate with a first tag having a lower energy state and a second tag having a higher energy state. The different energy states may mean that tags are active for different lengths of time. In some cases, the reader may attempt to communicate with a tag after the tag has deactivated (for example, if the tag is associated with a low energy state). Additionally, or alternatively, the reader may communicate with a tag having a higher energy state before a tag having a lower energy state, such that the tag having the lower energy state runs out of power before communicating with the reader, and the tag having the higher energy state has excess energy after communicating with the reader. Thus, efficiency of communication is decreased and power management of the tags is negatively impacted.

Some techniques described herein provide scheduling of communications of multiple tags based at least in part on energy states or priorities of the multiple tags. For example, a reader may communicate with a first tag and a second tag. The reader may communicate with the first tag using a first communication configuration, and with the second tag using a second communication configuration. The reader may communicate with the first tag based at least in part on a first energy state or a first priority of the first tag (e.g., the first communication configuration may be based at least in part on the first energy state), and may communicate with the second tag based at least in part on a second energy state or a second priority of the second tag (e.g., the second communication configuration may be based at least in part on the second energy state). A communication configuration (e.g., the first communication configuration or the second communication configuration) may indicate at least one of a communication occasion or a priority for a corresponding communication. By communicating in accordance with communication configurations that are based at least in part on energy states of the corresponding tags, scheduling of communications in view of the energy states of the tags is improved. Thus, efficiency of communication is increased. In some examples, a communication configuration may indicate that a tag having a lower energy state is associated with an earlier communication occasion (or a higher priority), or that a tag having a higher energy state is associated with a later communication occasion. Thus, a tag having a lower energy state may be enabled to communicate with a reader earlier than a tag having a higher energy state, which improves power management of the tags.

As indicated above, FIG. 6 is provided as an example. Other examples may differ from what is described with regard to FIG. 6.

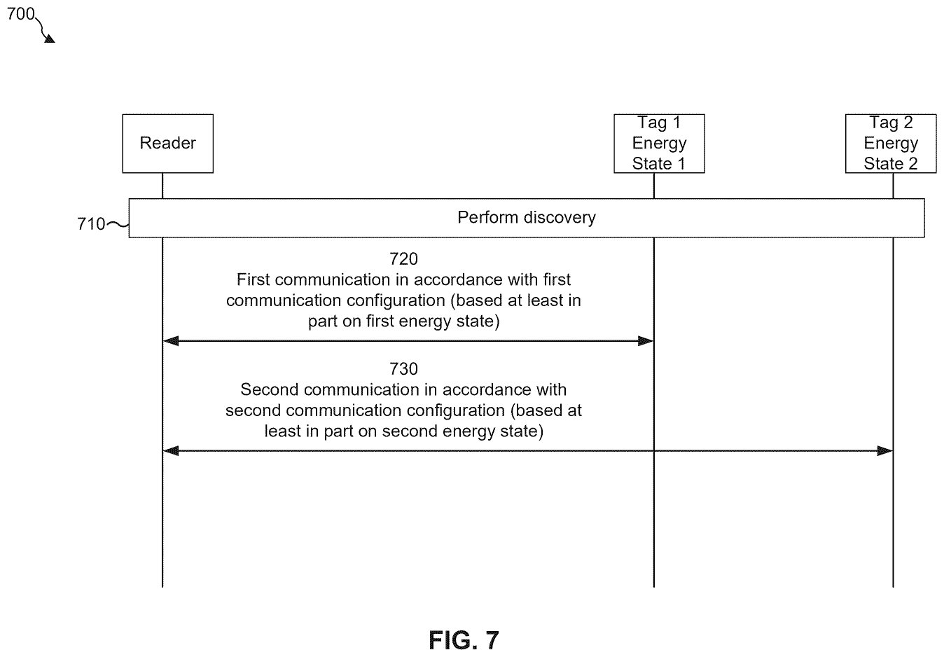

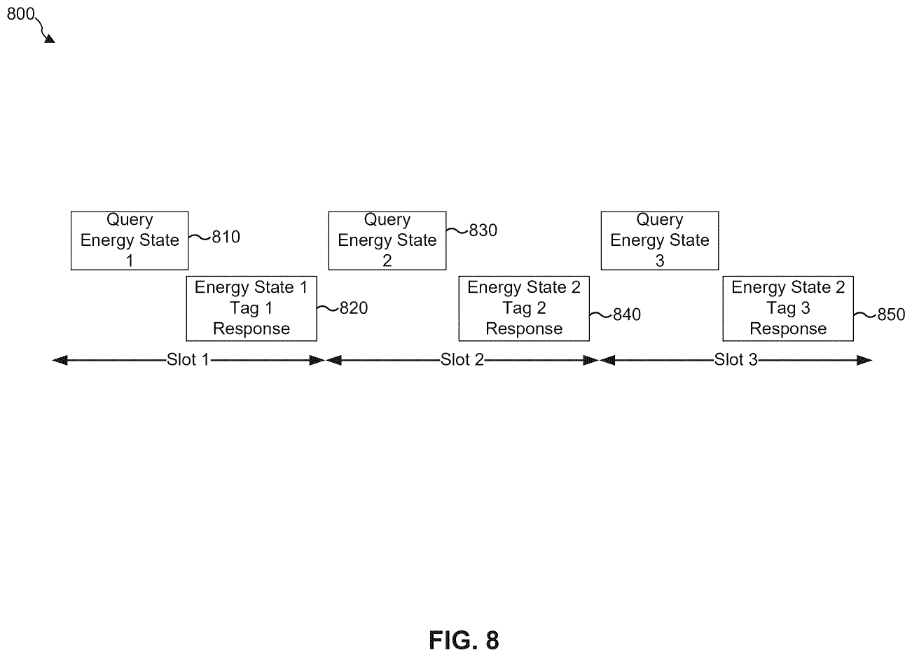

FIG. 7 is a diagram illustrating an example 700 of signaling relating to communication with tags having different energy states, in accordance with the present disclosure. As shown, example 700 includes a wireless communication device referred to hereinafter, and in connection with FIGS. 8-13, as a reader (e.g., UE 120, BS 110, an entity of a disaggregated base station, the reader of FIG. 5 or 6), a first tag (Tag 1) (e.g., UE 120, the tag of FIG. 5 or FIG. 6), and a second tag (Tag 2) (e.g., UE 120, the tag of FIG. 5 or FIG. 6). As shown, in example 700, the first tag has a first energy state and the second tag has a second energy state. The second energy state may be a higher energy state than the first energy state, meaning that the second tag may have a longer activity length or expected activity length than the first tag.

As shown by reference number 710, the reader, the first tag, and the second tag may perform discovery. Discovery may include one or more communications between the reader, the first tag, and the second tag. For example, during discovery, the reader may determine a number of nearby tags (e.g., within a threshold distance or a threshold signal strength of the reader), a class type of a tag (e.g., passive, semi-passive, active), a charging state, or the like.

In some aspects, the reader may determine an energy state of a tag during discovery. For example, the tag may transmit (e.g., via backscatter communication) information indicating an energy state of the tag (e.g., a number of bits may indicate a value that identifies the energy state). As another example, the reader may identify an activity length of the tag during discovery, and may determine the energy state using the activity length. In some aspects, a particular energy state may indicate that energy (or voltage) is available from an energy source of a tag, or an amount of available energy from the energy source. In some aspects, a particular energy state may indicate whether an LNA (for decoding and reception) is active and/or whether a PA (for transmission and encoding) is active. For example, a first energy state may indicate that the LNA and the PA are active, indicating large power consumption and an activity length of 50 ms. As another example, a second energy state may indicate that the LNA is active and the PA is inactive, indicating medium power consumption and an activity length of 100 ms. As another example, a second energy state may indicate that the LNA is inactive and the PA is active, indicating medium power consumption and an activity length of 200 ms. As another example, a second energy state may indicate that the LNA and the PA are both inactive, indicating low power consumption and an activity length of 2000 ms.

In some aspects, the reader may transmit configuration indicating for a tag to use an energy state or priority (e.g., based at least in part on a situation or conditions associated with the reader or the tag). For example, the reader may transmit an indication (e.g., a two-bit indication) in which each value of the indication can indicate a different energy state or priority. As another example, a preamble of a packet transmitted from the reader to the tag or from the tag to the reader may indicate an energy state or priority. For example, different preambles may correspond to different energy states or priorities.

As shown by reference number 720, the reader may perform a first communication with the first tag. As shown by reference number 730, the reader may perform a second communication with the second tag. As further shown, the first communication may be in accordance with a first communication configuration and the second communication may be in accordance with a second communication configuration. The first communication (e.g., the first communication configuration) may be based at least in part on the first energy state of the first tag, and the second communication (e.g., the second communication configuration) may be based at least in part on the second energy state of the second tag. For example, the first communication configuration may correspond to or be mapped to the first energy state, and the second communication configuration may correspond to or be mapped to the second energy state. The first communication or the second communication may include any form of signaling. In some aspects, the first communication may include an indication (e.g., a query) and/or a response to the indication. For example, the reader and the tag may perform the first communication in association with (e.g., in response to) an indication, or the first communication may include both the indication and the response. In some aspects, the second communication may include an indication (e.g., a query) and/or a response to the indication. In some aspects, the first communication and the second communication may include the same query (e.g., with respective responses to the query). FIGS. 8-13 provide some additional detail on communications with tags as described in connection with reference numbers 720 and 730.

In some aspects, a communication configuration indicates a communication occasion for a communication with a tag. A communication occasion may indicate time (e.g., a slot, a group of slots, a resource within a slot, referred to generally as a time occasion), frequency (e.g., a frequency channel, referred to generally as a frequency occasion), and/or code (e.g., a preamble, referred to generally as a code occasion) resources for transmission or reception of a communication using the communication configuration. In some aspects, a communication configuration corresponding to a lower energy state (e.g., energy state 1, in example 700) may indicate a communication occasion occurring earlier than a communication configuration corresponding to a higher energy state (e.g., energy state 2, in example 700). Thus, communications with tags having a lower energy state (and thus a shorter activity length) are prioritized over communications with tags having a higher energy state (and thus a longer activity length). Table 2 provides an example of communication occasion timing (e.g., earlier versus later) for tags having different parameters corresponding to different energy states:

TABLE 2

| | | Communication |
|---|---|---|
| Example | | occasions |
| Tag class | Passive tag (no ES) | Later |
| | Semi-passive tag, | Earlier |
| | active tag | |
| Active | Tag with LNA (PA, | Later |
| components state | tunnel diode, etc) off | |
| | Tag with LNA (PA, | Earlier |
| | tunnel diode, etc) on | |
| Capacitor size | Small | Earlier |
| | Large | Later |
| Distance | Far | Earlier |
| | Near | Later |

In some aspects, a communication configuration may indicate a priority of a communication. For example, different priorities can be associated with different energy states for a tag. A table may define mappings between energy states and priorities. In some examples, a communication having a lower energy state may be mapped to a higher priority, and a communication having a higher energy state may be mapped to a lower priority. Thus, communications of tags with lower energy states (and thus shorter activity lengths) may be prioritized over communications of tags with higher energy states, thereby improving energy management of tags and increasing reliability of communications. If a communication having a higher priority conflicts (e.g., is transmitted or received on the same resources as) a communication having a lower priority, the reader may drop (e.g., cancel, delay) the communication having a lower priority based at least in part on the higher priority (e.g., due to the lower priority being lower than the higher priority), and may respond to or perform the communication having a higher priority. In another example, a communication having a higher priority may preempt a communication having a lower priority. For example, the reader may cancel a communication occasion for the communication having a lower priority in order to respond to a tag associated with an energy state corresponding toa higher priority. Additionally, or alternatively, a communication configuration may indicate a delay threshold (e.g., a delay demand, information indicating a maximum delay for a communication of a tag). For example, a communication having a lower energy state may be associated with a lower delay threshold, and a communication having a higher energy state may be associated with a higher delay threshold.

In some aspects, a communication configuration may indicate a priority based at least in part on a distance threshold. For example, a first tag that is closer to the reader than a second tag may be assigned a lower priority, whereas the second tag may be assigned a higher priority. Thus, communications that are more prone to failure due to a larger distance between the reader and the tag can be prioritized.

In some aspects, the reader may transmit, and a tag may receive, an indication of whether the reader is associated with a mobility state. A mobility state may indicate that the reader has previously been, will be, or is in motion. For example, the mobility state may indicate that the reader is associated with at least a threshold speed, acceleration, or displacement. As another example, the mobility state may indicate that the reader is affixed to a moving platform. In some aspects, a mobility state may indicate that a distance between the reader and a tag is expected to change by a threshold distance. If the reader is associated with the mobility state, it may be expected that the reader may move within a certain distance of the tag in the future, which may enable the tag to wait for the reader to move within the certain distance, thereby improving communication efficiency and channel quality between the tag and the reader.

In some aspects, the first communication or the second communication may be based at least in part on a threshold distance. The threshold distance may indicate a maximum distance, between the reader and a tag, at which the tag is expected to respond to a query. If the distance between the reader and the tag satisfies the threshold distance (e.g., is greater than the threshold distance, is greater than or equal to the threshold distance), then the tag may not respond to a query, thereby conserving power of the tag. If the distance does not satisfy the threshold distance (e.g., is less than the threshold distance, is less than or equal to the threshold distance), then the tag may respond to the query, thereby improving reliability of communication with the tag. The distance between the reader and the tag may be determined by the reader, signaled by the tag, or the like. The threshold distance may be configured by the reader, configured by another network entity, or specified in a wireless communication specification.

As indicated above, FIG. 7 is provided as an example. Other examples may differ from what is described with regard to FIG. 7.

FIGS. 8-13 relate to communications between tags and a wireless communication device such as a reader, such as the first communication shown by reference number 720 and the second communication shown by reference number 730. References to a reader in FIGS. 8-13 should be understand to disclose a wireless communication device that comprises a reader. In FIGS. 8-13, multiple different energy states or priorities are described. An energy state is indicated by an index (e.g., “Energy state 1”). A lower index indicates a lower energy state (corresponding to a shorter activity length). In FIGS. 8-13, queries are transmitted by a reader, and responses are transmitted by tags that receive a query. In some examples, the reader may transmit additional communications, such as an indication of a conflict between two or more different communications.

FIG. 8 is a diagram illustrating an example 800 of signaling for communication based at least in part on energy states, in accordance with the present disclosure. Example 800 is an example where a reader can indicate a target energy state for a communication.

As shown by reference number 810, a reader may transmit a first query indicating a first energy state. As shown by reference number 820, a first tag associated with the first energy state may transmit (e.g., using backscattering communication or another form of transmission) a response. In some aspects, the reader may transmit the query in accordance with a first communication configuration. For example, the reader may transmit the query on a communication occasion indicated by the first communication configuration. In some aspects, the first tag may transmit the response in accordance with the first communication configuration. For example, the first tag may transmit the response on a communication occasion indicated by the first communication configuration. A communication performed in response to an indication (e.g., a query) may be referred to herein as being performed in association with the indication.

As shown by reference number 830, the reader may transmit, after the first query, a second query indicating a second energy state. The second energy state may be higher than the first energy state. For example, energy states indicated by different queries may be arranged in increasing order, such that tags having lower energy states are queried before tags having higher energy states, thereby reducing the likelihood that a tag having a lower energy state runs out of energy before communicating with the reader. In this way, the reader may transmit a second query after a first query based at least in part on the first energy state being a lower energy state than the second energy state.As shown by reference number 840, a second tag associated with the second energy state may transmit (e.g., using backscattering communication or another form of transmission) a response. In some aspects, the reader may transmit the second query in accordance with a second communication configuration. For example, the reader may transmit the query on a communication occasion indicated by the second communication configuration (which may be after a communication occasion for a first query or a response associated with a first energy level). In some aspects, the second tag may transmit the response in accordance with the second communication configuration. For example, the second tag may transmit the response on a communication occasion indicated by the second communication configuration (which may be after a communication occasion for a first query or a response associated with a first energy level).

As shown by reference number 850, in some aspects, a tag associated with a given energy level may transmit a response to a query that indicates a different energy level than the different energy level. For example, a tag may be permitted to transmit a response to a query that indicates an energy level that is higher than an energy level of the tag. In example 800, a third tag, associated with a second energy state, transmits a response to a query indicating a third energy state, where the third energy state is a higher energy state than the second energy state. Thus, tags with lower energy states have increased flexibility to communicate when power is available, thereby increasing efficiency of such tags.

In some aspects, a given energy state (e.g., a query relating to a given energy state, communications associated with the given energy state) may be associated with one or more slots. For example, communications associated with tags having a first energy state may be configured in a first set of slots and communications associated with tags having a second energy state may be configured in a second set of slots. In some aspects, a total number of slots (e.g., including the first set of slots and the second set of slots, in this example), the first number of slots, and/or the second number of slots may be determined based at least in part on historical records (e.g., a number of slots used for communications with tags in the past).

As indicated above, FIG. 8 is provided as an example. Other examples may differ from what is described with regard to FIG. 8. For example, example 800 may incorporate one or more features described with regard to FIG. 7.

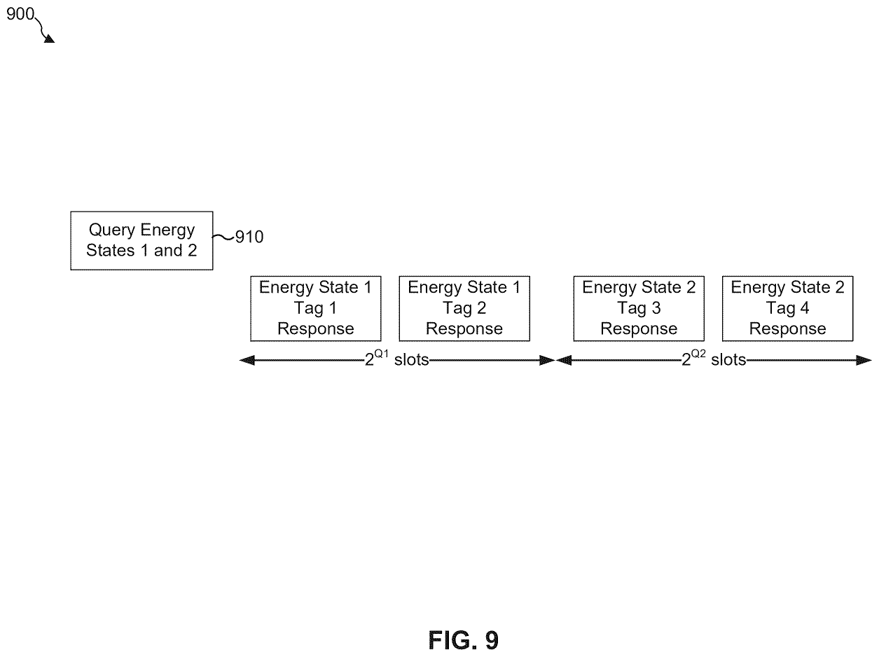

FIG. 9 is a diagram illustrating an example 900 of signaling for communication based at least in part on energy states, in accordance with the present disclosure. Example 900 is an example where a reader can use a shared indication to query tags associated with multiple different energy states.

As shown by reference number 910, the reader may transmit an indication indicating multiple energy states. For example, the reader may transmit a query indicating multiple energy states. In example 900, the query indicates a first energy state and a second energy state. In some aspects, the indication may indicate a first communication occasion (e.g., a first set of slots, which can include any number of slots such as Q1 slots, and which is shown in example 900 as including 2^{Q1} slots) for tags of the first energy state and/or a second communication occasion (e.g., a second set of slots, which can include any number of slots such as Q2 slots, and which is shown in example 900 as including 2^{Q2} slots). In some aspects, a configuration of the reader and/or a tag (e.g., the corresponding communication configuration for the energy state of the tag or another configuration) may indicate an offset (e.g., in the time domain) that indicates a communication occasion for the tag. For example, in example 900, the offset may include a first offset between the indication and a start of the set of 2^{Q1} slots (or a resource for an individual response from Tag 1 or Tag 2) and/or a second offset between the indication and a start of the set of 2^{Q2} slots (or a resource for an individual response from Tag 3 or Tag 4).

As indicated above, FIG. 9 is provided as an example. Other examples may differ from what is described with regard to FIG. 9. For example, example 900 may incorporate one or more features described with regard to FIG. 7 or FIG. 8.

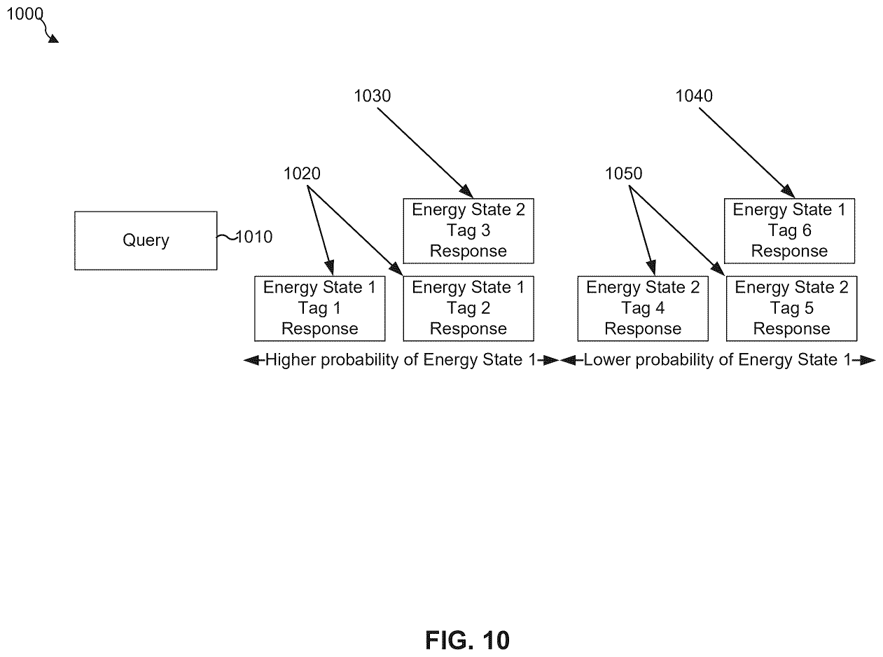

FIG. 10 is a diagram illustrating an example 1000 of signaling for communication based at least in part on energy states, in accordance with the present disclosure. Example 1000 is an example where a given energy state has different probabilities for transmission on different communication occasions.

As shown by reference number 1010, the reader may transmit, and a plurality of tags may receive, an indication (e.g., a query). As shown by reference number 1020, a first set of tags associated with a first energy state may respond to the indication in a first set of slots. As shown by reference number 1030, a second set of tags (including a single tag in example 1000) associated with a second energy state may respond to the indication in the first set of slots. As shown by reference number 1040, a third set of tags associated with the first energy state (in example 1000, a single tag) may respond to the indication in a second set of slots. As shown by reference number 1050, a fourth set of tags associated with the second energy state may respond to the indication in the second set of slots.

In some aspects, a communication configuration may indicate a probability for transmission on a given transmission occasion. For example, a first communication configuration (corresponding to the first energy state) may indicate a first probability for transmission in the first set of slots. If the first probability is ⅔, for example, it may be expected that two out of three tags, associated with the first energy state and that receive the indication, transmit in the first set of slots, as is illustrated in FIG. 10. A second communication configuration (corresponding to the second energy state) may indicate a second probability for transmission in the second set of slots. If the second probability is ⅔, for example, it may be expected that two out of three tags, associated with the second energy state and that receive the indication, transmit in the second set of slots, as is illustrated in FIG. 10. It should also be understood that the first communication configuration may explicitly or implicitly (e.g., by derivation from the first probability) indicate a third probability for transmission in the second set of slots. The first probability may be higher than the third probability because the first energy state is lower than the second energy state. Thus, tags having a lower energy state may be probabilistically more likely to occupy resources that are closer, in the time domain, to the indication, and tags having a higher energy state may be probabilistically less likely to occupy such resources.

As indicated above, FIG. 10 is provided as an example. Other examples may differ from what is described with regard to FIG. 10. For example, example 1000 may incorporate one or more features described with regard to FIG. 7, FIG. 8, or FIG. 9.

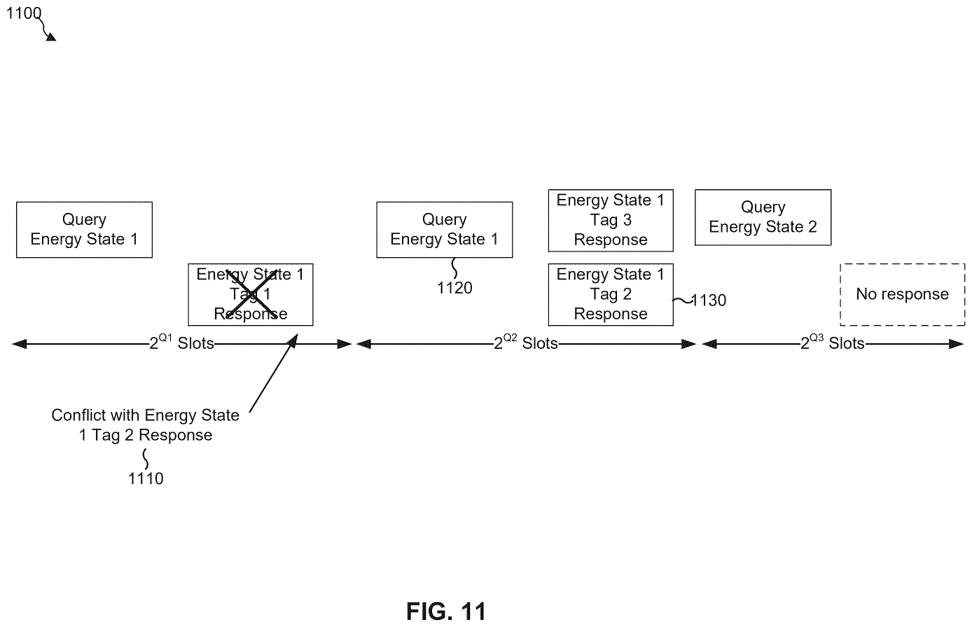

FIG. 11 is a diagram illustrating an example 1100 of signaling for communication based at least in part on energy states, in accordance with the present disclosure. Example 1100 is an example of conflict handling for tags having the same energy state. A conflict may occur, for example, when multiple tags respond to the same query on the same communication occasion and/or when a tag-initiated communication occurs on the same communication occasion as another tag-initiated communication or a response to a query.

As shown by reference number 1110, a conflict may occur in a first set of slots (2^{Q1} slots in example 1100) between a communication of a first tag (Tag 1) having a first energy state and a communication of a second tag (Tag 2) having the first energy state. For example, the first tag and the second tag may both attempt to respond to the indication (e.g., the query). In some aspects, the reader may identify the conflict based at least in part on attempting to receive the communication of the first tag and the communication of the second tag. In some aspects, the reader may successfully receive the communication of the first tag in the first set of slots. As shown by reference number 1120, the reader may transmit a second indication (e.g., query) indicating the first energy state. The second tag may perform a communication based at least in part on (e.g., in response to) the second indication. For example, the reader may repeatedly query a given energy state until no conflicts occur between communications corresponding to the given energy state. As another example, the reader may repeatedly query a lowest energy state until no responses are received for the lowest energy state, which may be possible because all tags are in the lowest energy state for some period of time before transitioning to an off state. As shown by reference number 1130, the second tag may transmit a second communication, associated with the first energy state, in response to the second indication. For example, the second tag may transmit the second communication based at least in part on (e.g., in response to) the communication of the second tag conflicting with the communication of the first tag. Thus, the conflict is resolved. As further shown, a third tag (e.g., Tag 3) associated with the first energy state may respond to the second indication. After transmitting the second indication, the reader may transmit a third indication (e.g., a query) indicating a second energy state. In this example, the reader receives no responses to the third indication.

As indicated above, FIG. 11 is provided as an example. Other examples may differ from what is described with regard to FIG. 11. For example, example 1100 may incorporate one or more features described with regard to FIG. 7, FIG. 8, FIG. 9, or FIG. 10.

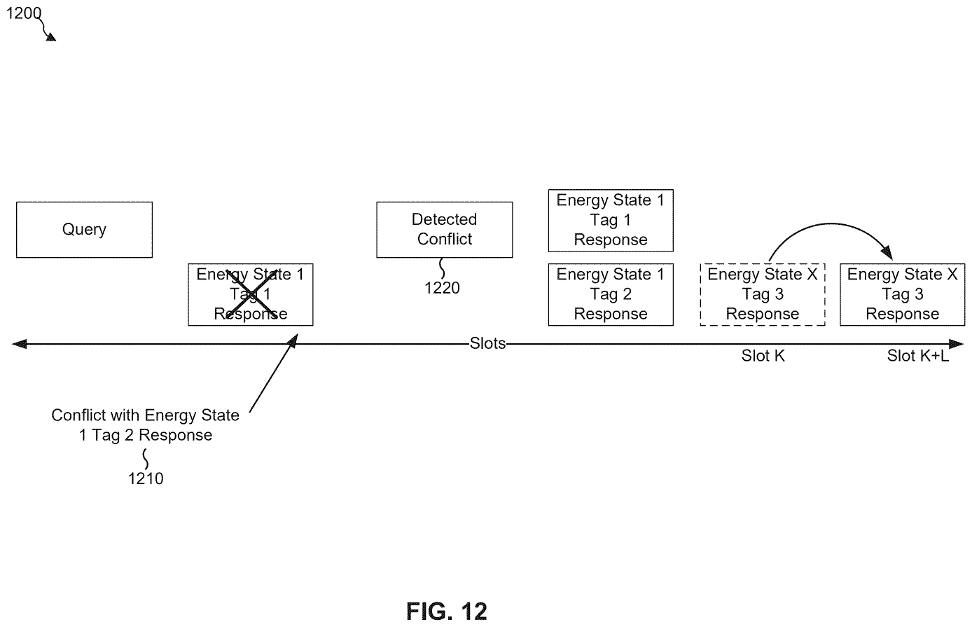

FIG. 12 is a diagram illustrating an example 1200 of signaling for communication based at least in part on energy states, in accordance with the present disclosure. Example 1200 is an example of conflict handling based at least in part on an indication of a detected conflict.

As shown by reference number 1210, a conflict may occur between communications of a first tag (Tag 1) and a second tag (Tag 2) associated with a first energy state. As shown by reference number 1220, the reader may transmit an indication of the conflict. The indication of the conflict may include a query indicating the first energy state, information indicating resources on which to respond to the indication, information indicating to retransmit the conflicting communication, information indicating to transmit a communication in response to the indication, or the like. As shown, the first tag and the second tag may transmit communications based at least in part on (e.g., in response to) the indication shown by reference number 1220, which resolves the conflict.

In some aspects, another tag (in example 1200, Tag 3, associated with an energy state X, where X is not equal to 1) may transmit a communication based at least in part on the indication of the conflict. For example, Tag 3 may postpone a communication from a scheduled slot K to a subsequent slot K+L, where L is any number (e.g., an integer). Thus, conflict is avoided.

As indicated above, FIG. 12 is provided as an example. Other examples may differ from what is described with regard to FIG. 12. For example, example 1200 may incorporate one or more features described with regard to FIG. 7, FIG. 8, FIG. 9, FIG. 10, or FIG. 11.

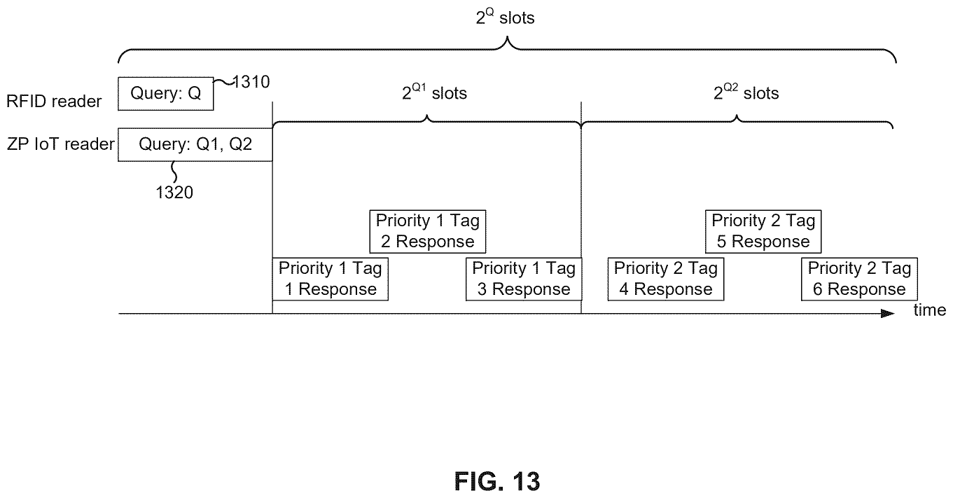

FIG. 13 is a diagram illustrating an example 1300 of signaling for communication based at least in part on priorities, in accordance with the present disclosure. As shown, example 1300 includes a wireless communication device such as a reader, which may be an RFID reader or a zero power IoT reader, among other examples. Further, example 1300 includes a plurality of tags, shown as Tag 1 through Tag 6.

In example 1300, communication configurations of the plurality of tags may indicate communication occasions that are based at least in part on priorities of the plurality of tags. For example, a communication configuration may indicate a first set of communication occasions (occurring, in example 1300, in a first set of slots shown as 2^{Q1} slots) corresponding to a first priority (shown as Priority 1). Additionally, or alternatively, a communication configuration may indicate a second set of communication occasions (occurring, in example 1300, in a first set of slots shown as 2^{Q2} slots) corresponding to a second priority (shown as Priority 2). Thus, a communication occasion may be based at least in part on a priority in that the communication occasion is for tags that are assigned the priority. These priorities can be signaled via any suitable form of signaling, preconfigured for a tag, configured by the reader, or determined based at least in part on traffic of a tag.

As shown, the reader may transmit an indication (e.g., a query). In some aspects, the indication may be for any tag, as shown by reference number 1310. For example, the indication may not indicate a specific priority. In some other aspects, the indication may indicate one or more priorities (in example 1300, two priorities, shown as Q1 and Q2 and including the first priority and the second priority), as shown by reference number 1320. As shown, tags having the first priority (e.g., Tag 1, Tag 2, and Tag 3) may respond to the indication (e.g., the indication shown by reference number 1310 or the indication shown by reference number 1320) in a communication occasion corresponding to the first priority. As shown, tags having the second priority (e.g., Tag 4, Tag 5, and Tag 6) may respond to the indication (e.g., the indication shown by reference number 1310 or the indication shown by reference number 1320) in a communication occasion corresponding to the second priority. Thus, communication configurations (such as the communication occasions indicated by the communication configurations) may be dependent on priorities of the corresponding tags, which enables prioritization (in time, frequency, or code) of communication with higher priority tags over communication with lower priority tags.

As indicated above, FIG. 13 is provided as an example. Other examples may differ from what is described with regard to FIG. 13. For example, example 1300 may incorporate one or more features described with regard to FIG. 7, FIG. 8, FIG. 9, FIG. 10, FIG. 11, or FIG. 12.

While techniques described herein are often described with regard to communication configurations corresponding to energy states, these techniques can also be applied for communication configurations that are independent of energy states. For example, a communication configuration for a communication with a tag can be derived from a priority assigned to the tag.

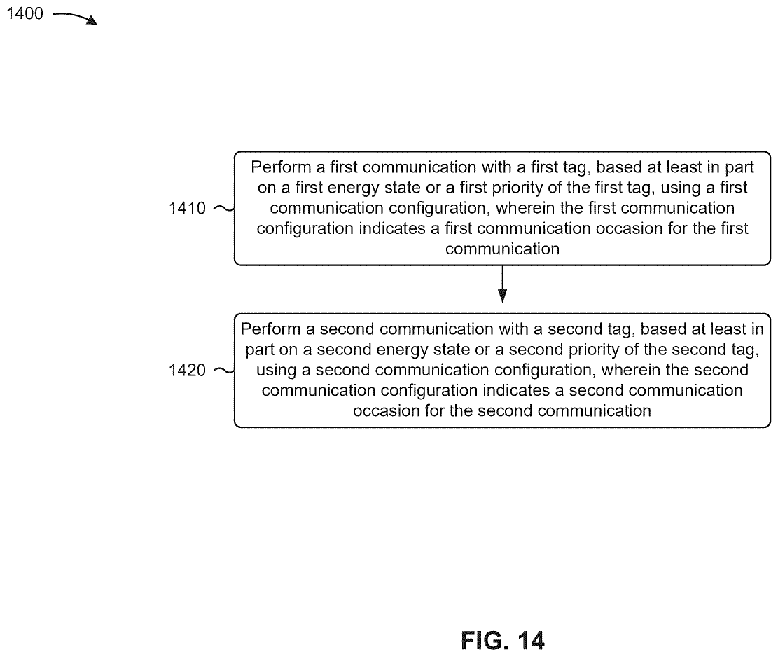

FIG. 14 shows a method 1400 for wireless communications by a wireless communication device, such as UE 120, BS 110, an entity of a disaggregated BS, or a reader (e.g., the reader of FIGS. 7-13).

Method 1400 begins at 1410 with performing a first communication with a first tag, based at least in part on a first energy state or a first priority of the first tag, using a first communication configuration, wherein the first communication configuration indicates a first communication occasion for the first communication. The first communication may include one or more of a query, a response to the query, or a tag-initiated communication.

Method 1400 then proceeds to step 1420 with performing a second communication with a second tag, based at least in part on a second energy state or a second priority of the second tag, using a second communication configuration, wherein the second communication configuration indicates a second communication occasion for the second communication. The second communication may include one or more of a query, a response to the query, or a tag-initiated communication.

In some aspects, the first energy state indicates at least one of available energy at the first tag, whether one or more amplifiers (e.g., a PA and/or an LNA) are active at the first tag, a class type of the first tag, an amount of available energy from an energy source of the first tag, or an expected activity length of the first tag.

In some aspects, method 1400 includes performing the first communication based at least in part on the first energy state, and performing the second communication based at least in part on the second energy state. In some aspects, method 1400 includes performing the first communication based at least in part on the first priority, and performing the second communication based at least in part on the second priority.

In some aspects, method 1400 includes receiving signaling indicating at least one of the first energy state or the second energy state.

In some aspects, method 1400 includes transmitting configuration information indicating for the first tag to use the first energy state.

In some aspects, the first energy state indicates a first expected activity length, the second energy state indicates a second expected activity length, the first expected activity length is shorter than the second expected activity length, and performing the first communication further comprises performing the first communication before the second communication occasion.

In some aspects, performing the first communication further comprises performing the first communication on the first communication occasion, and performing the second communication further comprises performing the second communication on the second communication occasion.

In some aspects, method 1400 includes performing the first communication in association with the first request.

In some aspects, method 1400 includes performing the second communication in association with the second request.

In some aspects, transmitting the second indication further comprises transmitting the second indication after the first indication based at least in part on the first energy state being a lower energy state than the second energy state.

In some aspects, method 1400 includes performing the first communication in association with the indication indicating the second energy state.

In some aspects, method 1400 includes performing the first communication and the second communication in association with the indication.

In some aspects, the first communication is associated with a first offset relative to the indication and the second communication is associated with a second offset, different than the first offset, relative to the indication.

In some aspects, the first communication configuration indicates a first probability for transmission on the first communication occasion and the second communication configuration indicates a second probability for transmission on the second communication occasion.

In some aspects, the first communication configuration indicates a third probability for transmission on the second communication occasion.

In some aspects, the first communication occasion occurs earlier, in time, than the second communication occasion, and the first probability is higher than the third probability based at least in part on the first energy state being a lower energy state than the second energy state.

In some aspects, performing the second communication further comprises performing the second communication in the second communication occasion based at least in part on another communication of the second tag conflicting with the first communication of the first tag in the first communication occasion.

In some aspects, the second energy state is a same energy state as the first energy state, performing the first communication further comprises performing the first communication based at least in part on a first indication indicating the first energy state, and performing the second communication further comprises performing the second communication based at least in part on a second indication indicating the first energy state.

In some aspects, method 1400 includes performing the first communication and the second communication based at least in part on the indication of the conflict.

In some aspects, the first communication occasion comprises at least one of a time occasion, a frequency occasion, or a code occasion.

In some aspects, the first priority is mapped to the first energy state and the second priority is mapped to the second energy state.

In some aspects, method 1400 includes dropping another communication, that conflicts with the first communication and that is associated with the second tag, based at least in part on the first priority.

In some aspects, performing the first communication further comprises performing the first communication based at least in part on the first tag being within a threshold distance of the wireless communication device.

In some aspects, the threshold distance is configured.

In some aspects, method 1400 includes transmitting, to the first tag or the second tag, an indication that the wireless communication device is associated with a mobility state.

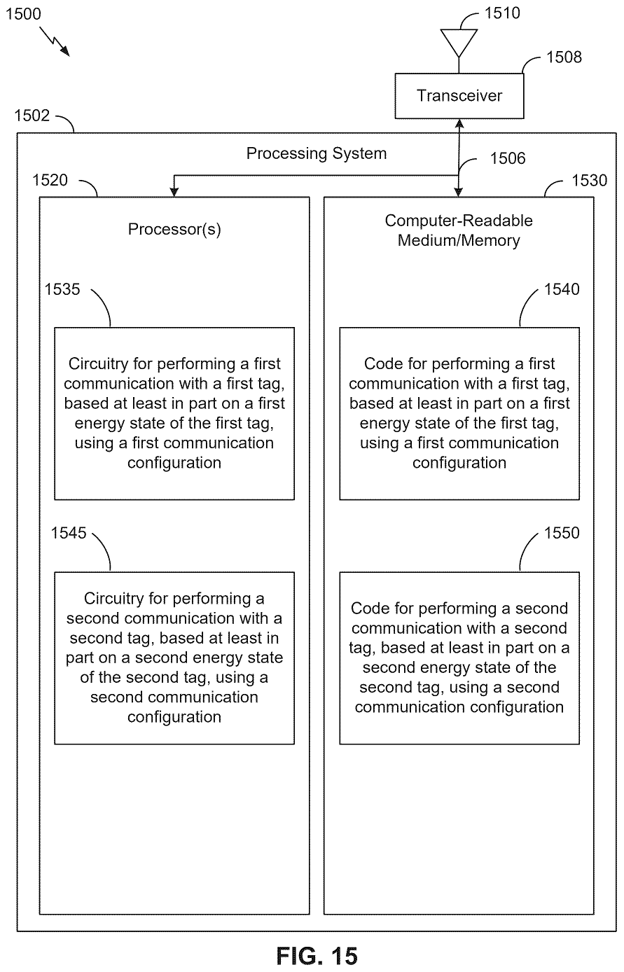

In one aspect, method 1400, or any aspect related to it, may be performed by an apparatus, such as communications device 1500 of FIG. 15, which includes various components operable, configured, or adapted to perform the method 1400. Communications device 1500 is described below in further detail.

Note that FIG. 14 is just one example of a method, and other methods including fewer, additional, or alternative steps are possible consistent with this disclosure.

FIG. 15 is a diagram illustrating an example of an implementation of code and circuitry for a communications device 1500, in accordance with the present disclosure. The communications device 1500 may be a wireless communication device, or a wireless communication device may include the communications device 1500.

The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may be representative of one or more of receive processor 258, transmit processor 264, TX MIMO processor 266, and/or controller/processor 280, as described with respect to FIG. 2. The one or more processors 1520 are coupled to a computer-readable medium/memory 1530 via a bus 1506. In various aspects, the computer-readable medium/memory 1530 may be representative of memory 282, as described with respect to FIG. 2. In certain aspects, the computer-readable medium/memory 1530 is configured to store instructions (e.g., computer-executable code, processor-executable code) that when executed by the one or more processors 1520, cause the one or more processors 1520 to perform the method 1400 described with respect to FIG. 14, or any aspect related to it. Note that reference to a processor performing a function of communications device 1500 may include one or more processors performing that function of communications device 1500.

As shown in FIG. 15, the communications device 1500 may include circuitry for performing a first communication with a first tag, based at least in part on a first energy state or a first priority of the first tag, using a first communication configuration, wherein the first communication configuration indicates at least one of a first communication occasion for the first communication or a first priority for the first communication (circuitry 1535).

As shown in FIG. 15, the communications device 1500 may include, stored in computer-readable medium/memory 1530, code for performing a first communication with a first tag, based at least in part on a first energy state or a first priority of the first tag, using a first communication configuration, wherein the first communication configuration indicates at least one of a first communication occasion for the first communication or a first priority for the first communication (code 1540).

As shown in FIG. 15, the communications device 1500 may include circuitry for performing a second communication with a second tag, based at least in part on a second energy state or a second priority of the second tag, using a second communication configuration, wherein the second communication configuration indicates at least one of a second communication occasion for the second communication or a second priority for the second communication (circuitry 1545).

As shown in FIG. 15, the communications device 1500 may include, stored in computer-readable medium/memory 1530, code for performing a second communication with a second tag, based at least in part on a second energy state or a second priority of the second tag, using a second communication configuration, wherein the second communication configuration indicates at least one of a second communication occasion for the second communication or a second priority for the second communication (code 1550).

Various components of the communications device 1500 may provide means for performing the method 1400 described with respect to FIG. 14, or any aspect related to it. For example, means for transmitting, sending, or outputting for transmission may include the transceiver(s) 254 and/or antenna(s) 252 of the UE 120 and/or transceiver 1508 and antenna 1510 of the communications device 1500 in FIG. 15. Means for receiving or obtaining may include the transceiver(s) 254 and/or antenna(s) 252 of the UE 120 and/or transceiver 1508 and antenna 1510 of the communications device 1500 in FIG. 15.

FIG. 15 is provided as an example. Other examples may differ from what is described in connection with FIG. 15.

The following provides an overview of some Aspects of the present disclosure:
Aspect 1: A method of wireless communication performed by a wireless communication device, comprising: performing a first communication with a first tag, based at least in part on a first energy state or a first priority of the first tag, using a first communication configuration, wherein the first communication configuration indicates at least one of a first communication occasion for the first communication or a first priority for the first communication; and performing a second communication with a second tag, based at least in part on a second energy state or a second priority of the second tag, using a second communication configuration, wherein the second communication configuration indicates at least one of a second communication occasion for the second communication or a second priority for the second communication.
Aspect 2: The method of Aspect 1, wherein performing the first communication with the first tag based at least in part on the first energy state or the first priority further comprises performing the first communication based at least in part on the first energy state, and performing the second communication with the second tag based at least in part on the second energy state or the second priority further comprises performing the second communication based at least in part on the second energy state.
Aspect 3: The method of Aspect 1, wherein the first energy state indicates at least one of: available energy at the first tag, whether one or more amplifiers are active at the first tag, or an expected activity length of the first tag.
Aspect 4: The method of any of Aspects 1-2, further comprising: receiving signaling indicating at least one of the first energy state or the second energy state.
Aspect 5: The method of any of Aspects 1-3, further comprising transmitting configuration information indicating for the first tag to use the first energy state.
Aspect 6: The method of any of Aspects 1-4, wherein the first energy state indicates a first expected activity length, the second energy state indicates a second expected activity length, the first expected activity length is shorter than the second expected activity length, and wherein performing the first communication further comprises performing the first communication before the second communication occasion.
Aspect 7: The method of any of Aspects 1-5, wherein performing the first communication further comprises performing the first communication on the first communication occasion and wherein performing the second communication further comprises performing the second communication on the second communication occasion.
Aspect 8: The method of any of Aspects 1-6, further comprising transmitting a first indication indicating the first energy state, wherein performing the first communication further comprises performing the first communication in association with the first request.
Aspect 9: The method of Aspect 7, further comprising transmitting a second indication after the first request, the second indication indicating the first energy state, wherein performing the second communication further comprises performing the second communication in association with the second request.
Aspect 10: The method of Aspect 8, wherein transmitting the second indication further comprises transmitting the second indication after the first indication based at least in part on the first energy state being a lower energy state than the second energy state.
Aspect 11: The method of any of Aspects 1-9, further comprising transmitting a indication indicating the second energy state, wherein the second energy state is a higher energy state than the first energy state, and wherein performing the first communication further comprises performing the first communication in association with the indication indicating the second energy state.
Aspect 12: The method of any of Aspects 1-10, further comprising transmitting an indication comprising a query, wherein performing the first communication and performing the second communication further comprise performing the first communication and the second communication in association with the indication.
Aspect 13: The method of Aspect 11, wherein the first communication is associated with a first offset relative to the indication and the second communication is associated with a second offset, different than the first offset, relative to the indication.
Aspect 14: The method of any of Aspects 1-12, wherein the first communication configuration indicates a first probability for transmission on the first communication occasion and the second communication configuration indicates a second probability for transmission on the second communication occasion.
Aspect 15: The method of Aspect 13, wherein the first communication configuration indicates a third probability for transmission on the second communication occasion.
Aspect 16: The method of Aspect 14, wherein the first communication occasion occurs earlier, in time, than the second communication occasion, and wherein the first probability is higher than the third probability based at least in part on the first energy state being a lower energy state than the second energy state.
Aspect 17: The method of any of Aspects 1-15, wherein performing the second communication further comprises performing the second communication in the second communication occasion based at least in part on another communication of the second tag conflicting with the first communication of the first tag in the first communication occasion.
Aspect 18: The method of Aspect 16, wherein the second energy state is a same energy state as the first energy state, wherein performing the first communication further comprises performing the first communication based at least in part on a first indication indicating the first energy state, and wherein performing the second communication further comprises performing the second communication based at least in part on a second indication indicating the first energy state.
Aspect 19: The method of Aspect 16, further comprising transmitting an indication of a conflict between the first communication and the other communication, wherein performing the first communication and performing the second communication further comprise performing the first communication and the second communication based at least in part on the indication of the conflict.
Aspect 20: The method of any of Aspects 1-18, wherein the first communication occasion comprises at least one of: a time occasion, a frequency occasion, or a code occasion.
Aspect 21: The method of Aspect 1, wherein performing the first communication with the first tag based at least in part on the first energy state or the first priority further comprises performing the first communication based at least in part on the first priority, and wherein performing the second communication with the second tag based at least in part on the second energy state or the second priority further comprises performing the second communication based at least in part on the second priority
Aspect 22: The method of any of Aspects 1-19, wherein the first priority is mapped to the first energy state and the second priority is mapped to the second energy state.
Aspect 23: The method of any of Aspects 1-20, further comprising dropping another communication, that conflicts with the first communication and that is associated with the second tag, based at least in part on the first priority.
Aspect 24: The method of any of Aspects 1-21, wherein performing the first communication further comprises performing the first communication based at least in part on the first tag being within a threshold distance of the wireless communication device.
Aspect 25: The method of Aspect 22, wherein the threshold distance is configured.
Aspect 26: The method of Aspect 22, further comprising transmitting, to the first tag or the second tag, an indication that the wireless communication device is associated with a mobility state.
Aspect 27: An apparatus for wireless communication at a device, comprising a processor; memory coupled with the processor; and instructions stored in the memory and executable by the processor to cause the apparatus to perform the method of one or more of Aspects 1-26.
Aspect 28: A device for wireless communication, comprising a memory and one or more processors coupled to the memory, the one or more processors configured to perform the method of one or more of Aspects 1-26.
Aspect 29: An apparatus for wireless communication, comprising at least one means for performing the method of one or more of Aspects 1-26.
Aspect 30: A non-transitory computer-readable medium storing code for wireless communication, the code comprising instructions executable by a processor to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of”′ a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A wireless communication device for wireless communication, comprising:
a memory; and
one or more processors, coupled to the memory, configured to:
perform a first communication with a first tag, based at least in part on a first energy state or a first priority of the first tag, using a first communication configuration, wherein the first communication configuration indicates a first communication occasion for the first communication; and
perform a second communication with a second tag, based at least in part on a second energy state or a second priority of the second tag, using a second communication configuration, wherein the second communication configuration indicates a second communication occasion for the second communication.

2. The wireless communication device of claim 1, wherein the one or more processors, to perform the first communication with the first tag based at least in part on the first energy state or the first priority, are configured to perform the first communication based at least in part on the first energy state, and wherein the one or more processors, to perform the second communication with the second tag based at least in part on the second energy state or the second priority, are configured to perform the second communication based at least in part on the second energy state.

3. The wireless communication device of claim 2, wherein the first energy state indicates at least one of:
available energy at the first tag,
whether one or more amplifiers are active at the first tag,
an expected activity length of the first tag,
a class type of the first tag, or
an amount of available energy from an energy source of the first tag.

4. The wireless communication device of claim 2, wherein the one or more processors are further configured to:
receive signaling indicating at least one of the first energy state or the second energy state.

5. The wireless communication device of claim 2, wherein the one or more processors are further configured to transmit configuration information indicating for the first tag to use the first energy state.

6. The wireless communication device of claim 2, wherein the first energy state indicates a first expected activity length, the second energy state indicates a second expected activity length, the first expected activity length is shorter than the second expected activity length, and wherein the one or more processors, to perform the first communication, are configured to perform the first communication before the second communication occasion.

7. The wireless communication device of claim 2, wherein the one or more processors, to perform the first communication, are configured to perform the first communication on the first communication occasion, and wherein the one or more processors, to perform the second communication, are configured to perform the second communication on the second communication occasion.

8. The wireless communication device of claim 2, wherein the one or more processors are further configured to transmit a first indication indicating the first energy state, wherein the one or more processors, to perform the first communication, are configured to perform the first communication in association with the first indication.

9. The wireless communication device of claim 8, wherein the one or more processors are further configured to transmit a second indication after the first indication, the second indication indicating the first energy state, wherein the one or more processors, to perform the second communication, are configured to perform the second communication in association with the second indication, wherein the one or more processors, to transmit the second indication, are configured to transmit the second indication after the first indication based at least in part on the first energy state being a lower energy state than the second energy state.

10. (canceled)

11. The wireless communication device of claim 2, wherein the one or more processors are further configured to transmit an indication indicating the second energy state, wherein the second energy state is a higher energy state than the first energy state, and wherein the one or more processors, to perform the first communication, are configured to perform the first communication in association with the indication indicating the second energy state.

12. The wireless communication device of claim 2, wherein the one or more processors are further configured to transmit an indication comprising a query, wherein the one or more processors, to perform the first communication and the second communication, are configured to perform the first communication and the second communication in association with the indication.

13. The wireless communication device of claim 12, wherein the first communication is associated with a first offset relative to the indication and the second communication is associated with a second offset, different than the first offset, relative to the indication.

14. The wireless communication device of claim 2, wherein the first communication configuration indicates a first probability for transmission on the first communication occasion and the second communication configuration indicates a second probability for transmission on the second communication occasion.

15. The wireless communication device of claim 14, wherein the first communication configuration indicates a third probability for transmission on the second communication occasion, wherein the first communication occasion occurs earlier, in time, than the second communication occasion, and wherein the first probability is higher than the third probability based at least in part on the first energy state being a lower energy state than the second energy state.

16. (canceled)

17. The wireless communication device of claim 2, wherein the one or more processors, to perform the second communication, are configured to perform the second communication in the second communication occasion based at least in part on another communication of the second tag conflicting with the first communication of the first tag in the first communication occasion.

18. The wireless communication device of claim 17, wherein the second energy state is a same energy state as the first energy state, wherein the one or more processors, to perform the first communication, are configured to perform the first communication based at least in part on a first indication indicating the first energy state, and wherein the one or more processors, to perform the second communication, are configured to perform the second communication based at least in part on a second indication indicating the first energy state.

19. The wireless communication device of claim 17, wherein the one or more processors are further configured to transmit an indication of a conflict between the first communication and the other communication, wherein the one or more processors, to perform the first communication and the second communication, are configured to perform the first communication and the second communication based at least in part on the indication of the conflict.

20. The wireless communication device of claim 1, wherein the first communication occasion comprises at least one of:
a time occasion,
a frequency occasion, or
a code occasion.

21. The wireless communication device of claim 1, wherein the one or more processors, to perform the first communication with the first tag based at least in part on the first energy state or the first priority, are configured to perform the first communication based at least in part on the first priority, and wherein the one or more processors, to perform the second communication with the second tag based at least in part on the second energy state or the second priority, are configured to perform the second communication based at least in part on the second priority.

22-26. (canceled)

27. A method of wireless communication performed by a wireless communication device, comprising:
performing a first communication with a first tag, based at least in part on a first energy state or a first priority of the first tag, using a first communication configuration, wherein the first communication configuration indicates a first communication occasion for the first communication; and
performing a second communication with a second tag, based at least in part on a second energy state or a second priority of the second tag, using a second communication configuration, wherein the second communication configuration indicates a second communication occasion for the second communication.

28. (canceled)

29. (canceled)
